(19) United States
(12) Patent Application Publication
(10) Pub. No.: US 2006/0111162 A1
(43) Pub. Date: May 25, 2006

(54) Portable wireless terminal having conductor for improving antenna property

(75) Inventors: Dong-Beom Seol, Suwon-si (KR); Chin-Sop Choe, Sungnam-si (KR); Jang-Hyun Nam, Suwon-si (KR); Cheol-Woong Park, Suwon-si (KR); Wan-Sang Ryu, Suwon-si (KR); Joo-Hwan Park, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/285,651

(22) Filed: Nov. 22, 2005

(30) Foreign Application Priority Data
Nov. 24, 2004 (KR) 10-2004-0096694
Mar. 16, 2005 (KR) 10-2005-0021747

(51) Int. Cl. H04M 1/00

(52) U.S. Cl. 455/575.5

(57) ABSTRACT

A portable wireless terminal with a built-in antenna module is provided. In the portable wireless terminal, a main body includes an upper case frame, a lower case frame, and a main board mounted between the upper and lower case frames. A built-in antenna module is disposed on the main board. A conductor is formed or mounted on at least one of the upper and lower case frames in the vicinity of the built-in antenna module, thereby preventing the degradation of the radiation of the built-in antenna module caused by an external interference and improving antenna performance.

### PRIORITY

This application claims priority under 35 U.S.C. § 119 to an application entitled “Portable Wireless Terminal Having Conductor For Improving Antenna Property” filed in the Korean Intellectual Property Office on Nov. 24, 2004 and assigned Serial No. 2004-96694 and “Portable Wireless Terminal Having Conductor For Improving Antenna Property” filed in the Korean Intellectual Property Office on Mar. 16, 2005 and assigned Serial No. 2005-21747 the contents of which are incorporated herein by reference.

### BACKGROUND OF THE INVENTION

1. Field of the Invention

The present invention relates generally to a portable wireless terminal with a built-in antenna, and in particular, to a portable wireless terminal configured to have a conductor in a case frame near a built-in antenna so that appropriate coupling between the conductor and the antenna device prevents the degradation of antenna radiation arising from a user's finger touch and increases a bandwidth, thereby ensuring a desired antenna radiation property.

2. Description of the Related Art

The recent widespread use of portable wireless terminals, such as Personal Communications Service (PCS) phones, Digital Communications Service (DCS) phones, Global Positioning System (GPS) terminals, Personal Digital Assistants (PDAs), cellular phones, and wireless laptop computers, is a driving force behind the appearance of terminals with diverse functionalities and designs. Along with the trend toward being of small size and being lightweight, the variety of functions that the terminals have attracts more and more attention. To meet these customers' demands, developmental work has focused on miniaturization of terminals with their functions maintained or enhanced.

Especially regarding an antenna device, a rod or whip antenna extended outward to a predetermined length, and a helical antenna are most vulnerable to damage in case of falling of a terminal and bring about problems that decrease portability. In this context, the use of a plate-type built-in antenna called an “internal antenna” or “antenna” has been growing, and efforts have been made to improve assembly and productivity as well as to enhance the properties of the built-in antenna.

FIG. 1 is a perspective view of a typical slide-type portable wireless terminal 100. However, the present invention is not limited to the slider-type and thus applicable to all other terminals including a folder type, a bar type, a flip type, etc.

Referring to FIG. 1, the portable wireless terminal 100 includes a main body 10 and a sliding body 20 movable up to a predetermined distance in a lengthwise direction on the main body 10. A display 21 is disposed on the front surface of the sliding body 20. The display 21 can be a wide color liquid crystal display (LCD) module, or preferably a touch screen panel. A speaker 22 is at an upper portion of the display 21, for receiving voice from the other party. At least one keypad assembly 23 is installed under the display 21. Preferably, the keypad assembly 23 includes navigation keys.

Another keypad assembly 11 having a plurality of keys can be provided on the surface of the main body 10 exposed when the sliding body 20 is opened along the main body 10. It preferably has digit keys in a 3×4 array. Under the keypad assembly 11 is disposed a microphone 12 for transferring voice from a user to the other party.

FIG. 2 is a rear view of the portable wireless terminal illustrated in FIG. 1, with marked areas for a built-in antenna and a finger touch adversely affecting antenna performance according to a conventional technology.

Referring to FIG. 2, a detachable battery pack 15 is provided as a power supply on the rear surface of the terminal 100, and a built-in antenna module is positioned inside a case frame 13 over the battery pack 15. It is preferred that the antenna module is installed along the width direction of the terminal 100. More specifically, it can be installed directly on a main board in a surface mounted device (SMD) manner, or mounted on an antenna carrier of a predetermined height. In FIG. 2, a dotted line indicated by an arrow A marks the position of the built-in antenna.

The above built-in antenna device, however, limits the shrink-down of the terminal in size because antenna performance is proportional to its size. Moreover, in the case of a planar inverted F antenna (PIFA)-type antenna module, as it becomes farther from the main board being a ground plane, it contributes more to improvement of antenna performance, but also blocks development of small-size, lightweight terminals.

When using a terminal, a user generally places his fingers on an area marked with a dotted line indicated by an arrow B in FIG. 2, right over the built-in antenna. As a result, the voltage standing wave ratio (VSWR) of the terminal is greatly changed, causing a mute phenomenon and degrading antenna radiation.

### SUMMARY OF THE INVENTION

An object of the present invention is to substantially solve at least the above problems and/or disadvantages and to provide at least the advantages below. Accordingly, an object of the present invention is to provide a portable wireless terminal having a conductor which is configured to prevent the degradation of an antenna property caused by external interference.

Another object of the present invention is to provide a portable wireless terminal having a conductor near a built-in antenna, which is configured to maximize an antenna property by reducing the variation of VSWR caused by external interference.

A further object of the present invention is to provide a portable wireless terminal having a conductor of a predetermined pattern to be coupled to a conventional built-in antenna device, thereby achieving a larger bandwidth and thus maximizing the radiation performance of a built-in antenna module.

According to one aspect of the present invention, in a portable wireless terminal, a main body includes an upper case frame, a lower case frame, and a main board of a predetermined size mounted between the upper and lower case frames. A built-in antenna module has a predetermined size and is disposed on the main board. A conductor of a predetermined shape is formed or mounted on at least one of the upper and lower case frames in the vicinity of the built-in antenna module, thereby preventing the degradation of the radiation of the built-in antenna module caused by an external interference and improving antenna performance.

A conductive plate can be used as the conductor. It is preferred that the conductive plate covers the antenna wholly or partially in the vicinity of the built-in antenna, to thereby achieve a constant predetermined transmission/reception sensitivity despite a user's finger touch.

It is preferred that the conductive plate can be applied to a case frame in different manners. For example, the conductive plate covers the case frame, or attached to the inner surface of the case frame. The conductive plate can be insertion-molded in the case frame during injection-molding of the case frame.

According to another aspect of the present invention, the conductor is electrically connected to a ground of the main board by a predetermined connector. The connector is one of a fine-wire cable and an FPC. The conductor is preferably electrically connected to electromagnetic interference (EMI) spray coated on the inner surface of the at least one case frame and the EMI spray is electrically connected to the ground of the main board.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a typical portable wireless terminal;

FIG. 2 illustrates a built-in antenna area and a finger touch area part that adversely affects an antenna property in a conventional portable wireless terminal;

FIGS. 3A, 3B and 3C are sectional views illustrating a part of a portable wireless terminal in which a conductor is installed according to various embodiments of the present invention;

FIG. 4 is a perspective view of a plate-type conductor in the portable wireless terminal according to an embodiment of the present invention;

FIGS. 5A and 5B are graphs illustrating VSWR variations before and after a finger touch in the case of the conductor illustrated in FIG. 4;

FIG. 6 is a perspective view of a patterned conductor in the portable wireless terminal according to an alternative embodiment of the present invention;

FIGS. 7A and 7B are graphs illustrating VSWR variations before and after a finger touch in the case of the conductor illustrated in FIG. 6;

FIGS. 8A and 8B are graphs illustrating VSWR variations before and after using a conductor in a GSM band according to a further embodiment of the present invention; and

FIGS. 9A and 9B are graphs illustrating VSWR variations before and after using the conductor in a DCS band according to the further embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

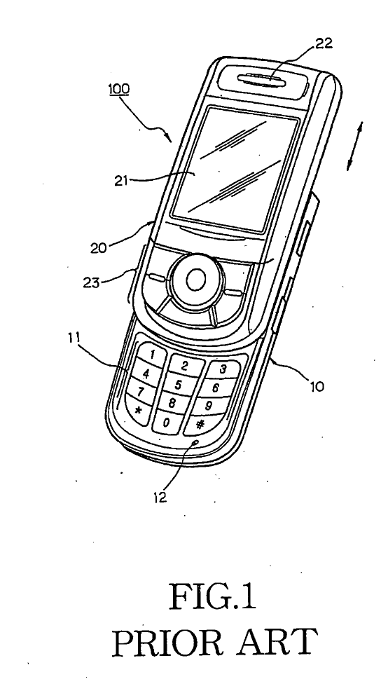

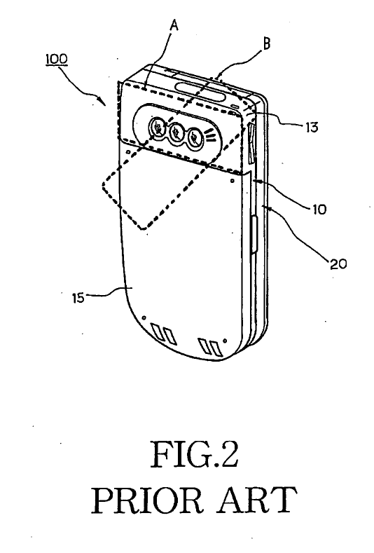

While the present invention is described in the context of a slider-type terminal illustrated in FIG. 1, it is not limited to the slider type. Hence, the present invention is applicable to all other-type terminals with built-in antenna modules such as a folder type, a bar type, and a flip type, and devices with built-in antenna modules such as a PDA and a laptop computer. Especially, the present invention is applicable to terminals with built-in antennas operating in a GSM, DCS or PCS band.

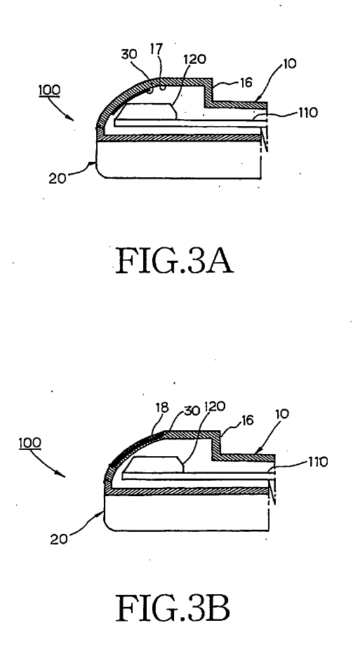

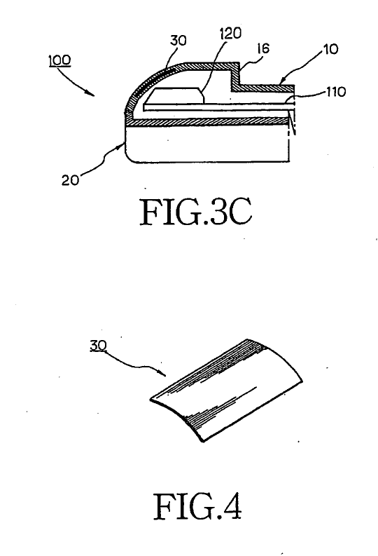

FIGS. 3A, 3B and 3C are sectional views of a of a portable wireless terminal in which a conductor is installed in different manners according to embodiments of the present invention. For simplicity, only a main body having a built-in antenna installed therein is shown.

Referring to FIG. 3A, a main board 110 is provided inside a main body 10. A built-in antenna module 120 is installed in an upper portion of the main body 110. As well known, in the case of a PIFA type, the built-in antenna module 120 has a feeding portion and a grounding portion, and in the case of a typical monopole antenna, it may have a feeding portion; In addition, the built-in antenna module 120 may have a radiator fixed on a predetermined antenna carrier.

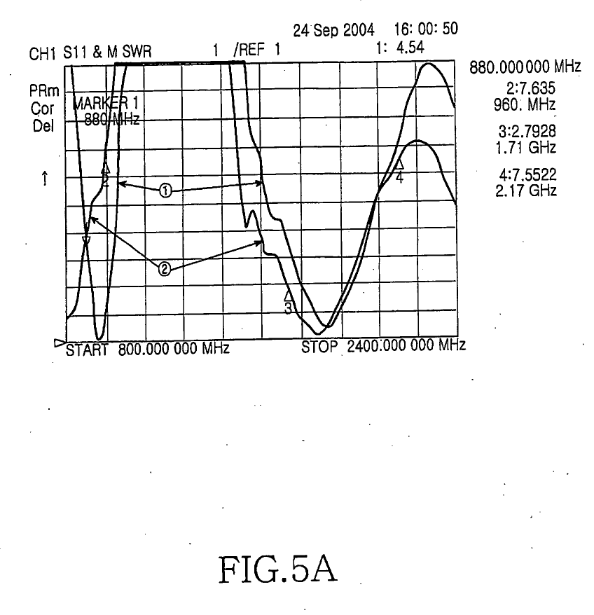

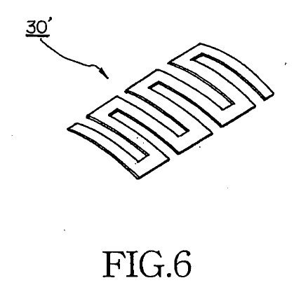

According to the present invention, a conductor 30 is mounted or attached to the antenna module 120, that is, the inner surface 17 of a case frame 16 in the main body 10. The conductor 30 can be copper, aluminum (Al) or SUS(Steel Use Stainless) tape, or a flexible printed circuit (FCB) attached or fixed to the inner surface 17 of the case frame 16 by a predetermined adhesive. The conductor 30 can be formed into a predetermined shape according to the characteristics of the antenna module used. For example, the conductor 30 may be shaped into a plate or a pattern, as illustrated in FIGS. 4 and 6.

In FIG. 3A, the conductive tape 30 is attached onto the inner surface 17 of the case frame 16 by a predetermined adhesive tape, or preferably, a conductive foam according to the present invention. FIG. 3B illustrates that the conductive tape 30 is attached on the outer surface of the case frame 16. In this case, a predetermined cover 18 may cover the conductive tape 30. Alternatively, the cover 18 is formed of a conductive material, instead of using the conductive tape 30. Then, the outer surface of the cover 18 can be coated with a predetermined paint to provide a better appearance. FIG. 3C illustrates that the conductor 30 is inserted into the case frame 16. Since the conductor 30 can be insertion-molded during injection-molding the case frame 16, there is no need for an additional process of attaching or fixing the conductor 30.

While not shown, it is further contemplated that an FPC patterned into a predetermined shape is attached on the inner surface of the case frame, or the inner surface of the case frame is coated to a predetermined thickness with a conductive spray in the form of the above-described conductor.

FIG. 4 is a perspective view of a plate-type conductor 30 for use in a portable wireless terminal according to an embodiment of the present invention the present invention. The plate-type conductor 30 is curved in correspondence with the shape of the case frame 16 illustrated in FIGS. 3A and 3B, to which the present invention is not limited. Thus, the conductor 30 can be shaped in correspondence with the shape of a case frame to which it is applied near a built-in antenna module.

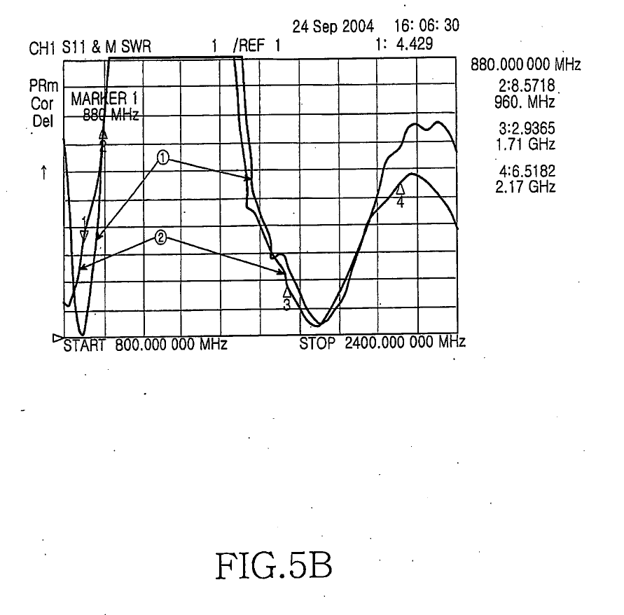

FIGS. 5A and 5B are graphs illustrating VSWR variations before and after a finger touch in the case of the conductor illustrated in FIG. 4. Specifically, FIG. 5A illustrates VSWR variations before and after a finger touch when the conductor is not applied and FIG. 5B illustrates VSWR variations before and after a finger touch when the conductor is applied. In FIGS. 5A and 5B, reference numerals ✓ and □ denote VSWR curves before and after a finger touch, respectively.

Table 1 below lists experimental results shown in FIGS. 5A and 5B.

TABLE 1

| | GSM band | | | DCS band | | |
|---|---|---|---|---|---|---|
| | Resonant | Resonant | | Resonant | Resonant | |
| | frequency | frequency | | frequency | frequency | |
| | before finger | after finger | Variation | before finger | before finger | Variation |
| | touch (MHz) | touch (MHz) | (%) | touch (MHz) | touch (MHz) | (%) |
| Before conductor | 934 | 800 | 14.3 | 1864 | 1827.6 | 1.95 |
| After conductor | 871.5 | 822.1 | 5.7 | 1848.4 | 1828.9 | 1.05 |

The change of resonant frequency before and after a finger touch in a GSM band is significantly reduced from about 14.3% to 5.7% as the conductor is applied. Also in a DCS band, the change of resonant frequency is decreased from 1.95% to 1.05%. Thus, it can be concluded that the use of the conductor leads to a considerable decrease in VSWR change with respect to an external interference such as a user's finger touch.

FIG. 6 is a perspective view illustrating a patterned conductor 30′ according to an embodiment of the present invention. This conductor 30′ is designed so as to increase a bandwidth. The conductor pattern 30′ can be formed using copper tape, a conductive spray, or an FPC.

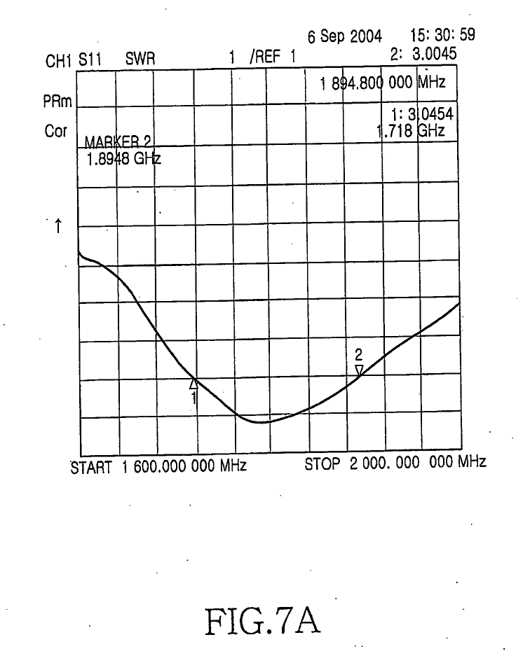

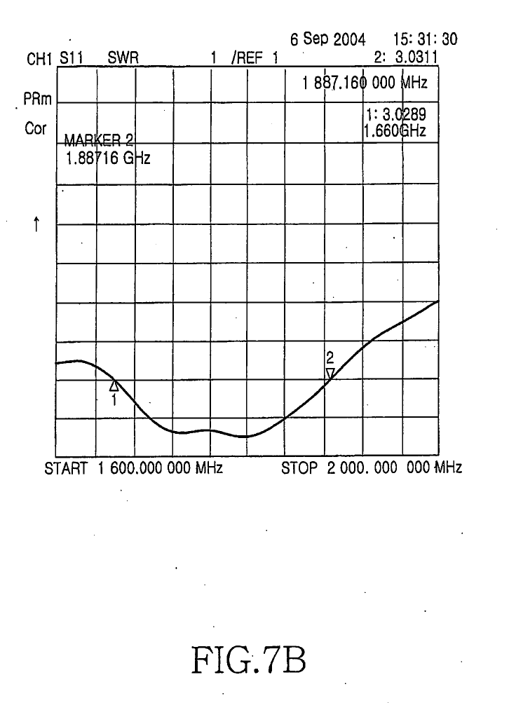

FIGS. 7A and 7B are graphs illustrating VSWR variations before and after using the conductor illustrated in FIG. 6. Specifically, FIG. 7A illustrates VSWR variations before the conductor is applied and FIG. 7B illustrates VSWR variations after the conductor is applied. As noted from the VSWR curves, the bandwidth at or below VSWR 3 is increased from 176 MHz before using the conductor to 227 MHz after using conductor.

While the conductor has been described to operate independently without any connector configuration in the vicinity of the built-in antenna, it is further contemplated as a further embodiment that the conductor is electrically connected to a ground of the main board. It is demonstrated that this conductor with a grounding configuration renders the antenna device to have substantially good performance according to the present invention.

The conductor is identical to that described above in terms of shape, position, and material, except that it is configured to be electrically connected to the ground of the main board.

Therefore, the conductor can be electrically connected to the ground of the main board in a known manner. For example, a direct electrical connection is made between the conductor and the main board by an FPC or a fine-wire cable, to which the present invention is not limited. For example, the conductor is electrically connected to electromagnetic interference (EMI) shielding spray coated on the inner surface of the case frame to shield electronic waves emitted from electronic parts mounted on the main board and, in turn, the EMI shielding spray is electrically connected to the main board. In other words, the conductor is electrically connected indirectly to the main board. Any other known electrical connection means is available to make a connection between the conductor and the main board.

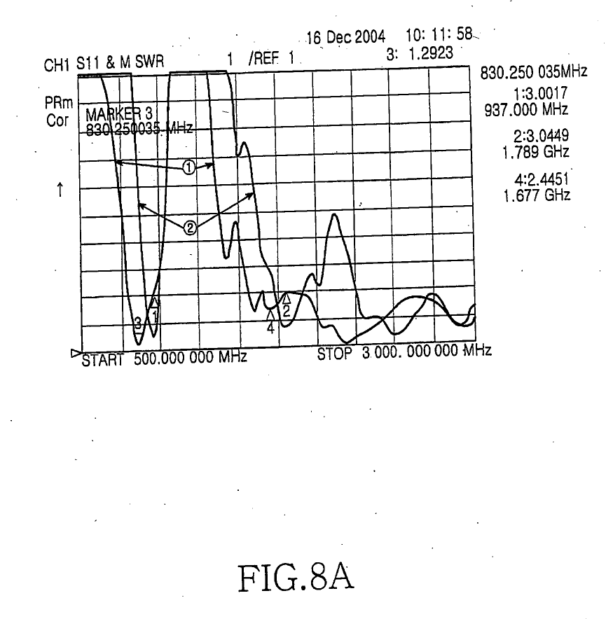

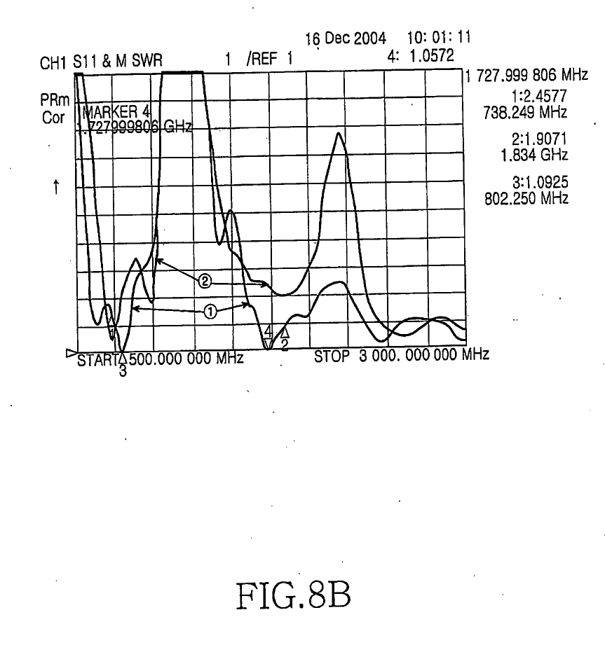

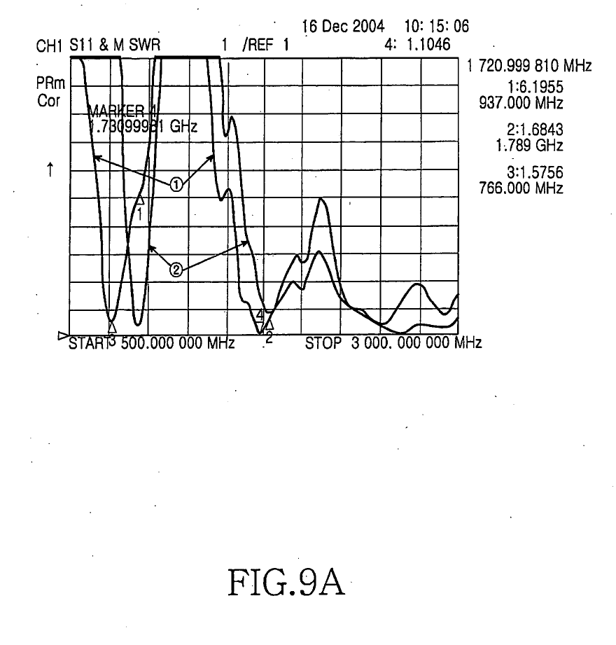

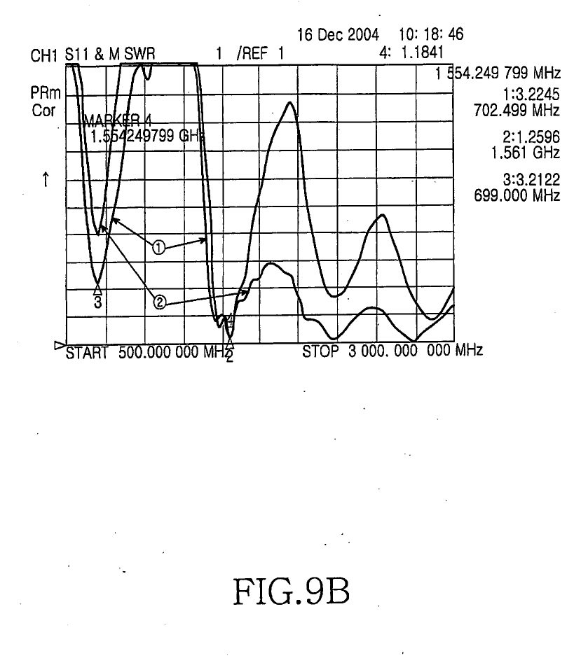

FIGS. 8A and 8B are graphs illustrating VSWR variations, respectively before and after using the conductor in a GSM band according to the further embodiment of the present invention. FIGS. 9A and 9B are graphs illustrating VSWR variations, respectively before and after using the conductor in a DCS band according to the further embodiment of the present invention.

The conductor used is configured to have a grounding configuration. In FIGS. 8A to 9B, reference numerals □ and □ denote VSWR curves before and after a finger touch, respectively. VSWR was measured in both cases under the same conditions.

The experimental results shown as the VSWR curves in FIGS. 8A to 9B are tabulated in Table 2 below.

TABLE 2

| | GSM band | | | DCS band | | |
|---|---|---|---|---|---|---|
| | Resonant | Resonant | | Resonant | Resonant | |
| | frequency | frequency | | frequency | frequency | |
| | before finger | after finger | Variation | before finger | before finger | Variation |
| | touch (MHz) | touch (MHz) | (%) | touch (MHz) | touch (MHz) | (%) |
| Before ground plate | 937 | 830 | 11.0 | 1789 | 1721 | 3.8 |
| After ground plate | 728 | 802 | 8.6 | 1561 | 1554 | 0.5 |

Table 2 reveals that the change of resonant frequency before and after a finger touch is substantially decreased from about 11.0% before using the conductor to 8.6% after using the conductor in a GSM band. The resonant frequency change in a DCS band is also remarkably reduced from 3.8% to 0.5%. In this way, the conductor having a grounding configuration also leads to a significant decrease in VSWR change with respect to an external interference such as a user's finger touch.

The present invention advantageously prevents the degradation of antenna radiation caused by an external interference by use of a conductor in the vicinity of a built-in antenna module, thereby improving antenna performance.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A portable wireless terminal comprising:
a main body including an upper case frame, a lower case frame, and a main board mounted between the upper and lower case frames;
a built-in antenna module of a predetermined size disposed on the main board; and
a conductor formed or mounted on at least one of the upper and lower case frames in the vicinity of the built-in antenna module to prevent degradation of the radiation of the built-in antenna module caused by an external interference.

2. The portable wireless terminal of claim 1, wherein the conductor is formed of one of copper, aluminum, SUS, and a flexible printed circuit (FPC).

3. The portable wireless terminal of claim 2, wherein the conductor fully covers the built-in antenna module.

4. The portable wireless terminal of claim 2, wherein the conductor partially covers the built-in antenna module.

5. The portable wireless terminal of claim 3, wherein the conductor is attached on an inner surface of at least one case frame.

6. The portable wireless terminal of claim 3, wherein the conductor is attached to an outer surface of at least one case frame and covered with an external cover.

7. The portable wireless terminal of claim 3, wherein the conductor is insertion-molded in at least one case frame during injection-molding of the at least one case frame.

8. The portable wireless terminal of claim 3, wherein the conductor is a conductive cover covering at least one case frame.

9. The portable wireless terminal of claim 2, wherein the conductor is a conductive spray coated into a predetermined shape on an inner surface of at least one case frame.

10. The portable wireless terminal of any of claims 1, wherein the conductor is electrically connected to a ground of the main board by a connector.

11. The portable wireless terminal of claim 9, wherein the conductor is electrically connected to an electromagnetic interference (EMI) spray coated on an inner surface of at least one case frame and the EMI spray is electrically connected to the ground of the main board.

12. The portable wireless terminal of claim 9, wherein the connector is one of a fine-wire cable and an FPC.
